(19) United States
(12) Patent Application Publication
(10) Pub. No.: US 2019/0337206 A1
(43) Pub. Date: Nov. 7, 2019

(54) INJECTION MOLDING APPARATUS AND METHOD OF INJECTION MOLDING

(71) Applicant: DME COMPANY LLC, Madison Hights, MI (US)

(72) Inventor: Kevin COCHRAN, Grand Rapids, MI (US)

(21) Appl. No.: 16/401,990

(22) Filed: May 2, 2019

Related U.S. Application Data
(60) Provisional application No. 62/665,811, filed on May 2, 2018.

(51) Int. Cl. B29C 45/26; B29C 45/17

(52) U.S. Cl. CPC B29C 45/2675; B29C 45/1756; B29C 45/2602

(57) ABSTRACT

An injection molding apparatus and a method of injection molding are disclosed. The injection molding apparatus includes a mold sub-platen assembly having a first sub-platen that is attachable to a stationary side portion of a mold base which is mountable to a stationary platen of an injection molding machine. The mold sub-platen assembly also includes a second sub-platen that is attachable to a moving side portion of the mold base that is mountable to a moving platen of the injection molding machine. The method includes attaching a set of guide pins to a mold sub-platen at locations that correspond to guide openings in a mold and installing the mold on the mold sub-platen such that the guide pins extend through guide openings in the first half of the mold and into guide openings in a second half of the mold.

### CROSS-REFERENCE TO RELATED APPLICATIONS

The application claims priority under 35 U.S.C. § 119(e) of U.S. Provisional Application No. 62/665,811, filed May 2, 2018, the contents of which are incorporated by reference herein in their entirety.

### TECHNICAL FIELD

The present invention relates to injection molding, and more particularly to injection molding of prototype parts.

### BACKGROUND

Prior to investing in production injection molding tooling and equipment to manufacture vast quantities of a part, a prototype mold is often used to evaluate design attributes of the part. While a prototype mold can be produced relatively quickly, it is often time consuming and requires secondary fitting operations to install the prototype mold in a molding machine considering the run of prototype parts can be, for example, as few as two to one hundred pieces.

### SUMMARY

Embodiments hereof are directed to an injection molding apparatus for use with a mold base mounted in an injection molding machine. The injection molding apparatus includes a mold sub-platen assembly includes a stationary side sub-platen that is releasably attachable to a stationary side portion of the mold base, which is mountable to a stationary platen of an injection molding machine. The mold sub-platen assembly also includes a moving side sub-platen that is releasably attachable to a moving side portion of the mold base, which is mountable to a moving platen of the injection molding machine.

Embodiments hereof are directed to a method of injection molding, the method includes attaching a set of guide pins to a stationary sub-platen at predetermined locations that correspond to guide openings that extend through a first half of a mold; installing the first half of the mold on the the stationary sub-platen such that the guide pins extend through the guide openings that extend through the first half of the mold; and installing a second half of the mold on the stationary sub-platen such that the guide pins extend from the guide openings in the first half of the mold and into guide openings that extend into the second half of the mold and are aligned with the guide openings that extend through the first half of the mold.

### BRIEF DESCRIPTION OF DRAWINGS

The foregoing and other features and advantages of the present disclosure will be apparent from the following description of embodiments thereof as illustrated in the accompanying drawings. The accompanying drawings, which are incorporated herein and form a part of the specification, further serve to explain the principles of the present disclosure and to enable a person skilled in the pertinent art to make and use the invention(s) taught in the present disclosure. The drawings may not be to scale.

FIG. 1 is a partially sectioned side view of an injection molding machine having a mold base mounted therein; a mold sub-platen assembly is coupled to the mold base and a mold is mounted in the mold sub-platen assembly 104.

FIG. 2 is a sectional view of the mold base and the mold sub-platen assembly taken along line 2-2 of FIG. 1.

FIG. 3 is a perspective view of the mold base and the mold sub-platen assembly 104 rotated from their in-use orientation for ease of viewing.

FIG. 4 is a perspective view depicting assembly of a stationary side sub-platen with a stationary side portion of the mold base.

FIG. 5 is a perspective view of the stationary side sub-platen assembled with the stationary side portion of the mold base.

FIG. 6 is a perspective view depicting assembly of a moving side sub-platen with a moving side portion of the mold base.

FIG. 7 is a perspective view of the moving side sub-platen assembled with the moving side portion of the mold base.

FIG. 8 is a front perspective view of a first mold which is suitable for use with the mold sub-platen assembly.

FIG. 9 is a rear perspective view of the first mold.

FIG. 10 is a perspective view of a molded article which the first mold is shaped to form.

FIG. 11 is a perspective view of a first half of the first mold installed on the stationary side sub-platen.

FIG. 12 is a perspective view of the first half of the first mold and a second half of the first mold installed on the stationary side sub-platen.

FIG. 13 is a perspective view of the assembled moving side sub-platen and moving side portion of the mold base separated from the stationary side sub-platen and the first prototype mold.

FIG. 14 is a perspective view showing extraction of the article formed in the first mold from the mold cavity in which it was formed

FIG. 15 is a front perspective view of a second mold which is suitable for use with the mold sub-platen assembly.

FIG. 16 is a rear perspective view of the second mold.

FIG. 17 is a perspective view of a molded article which the second mold is shaped to form.

FIG. 18 is a perspective view of the mold sub-platen assembly configured to receive the second mold.

FIG. 19 is a perspective view of a first half of the second mold installed on the stationary side sub-platen.

FIG. 20 is a perspective view of the first half of the second mold and a second half of the second mold installed on the stationary side sub-platen.

### DETAILED DESCRIPTION

Specific embodiments of the present disclosure are now described with reference to the figures. The following detailed description is merely exemplary in nature and is not intended to limit the disclosure or the application and uses of the disclosure. In the following description, “downstream” is used with reference to the direction of mold material flow from an injection unit of an injection molding machine to a mold cavity of a mold of an injection molding system, and also with reference to the order of components or features thereof through which the mold material flows from the injection unit to the mold cavity, whereas “upstream” is used with reference to the opposite direction. Furthermore, there is no intention to be bound by any expressed or implied theory presented in the preceding technical field, background, summary or the following detailed description.

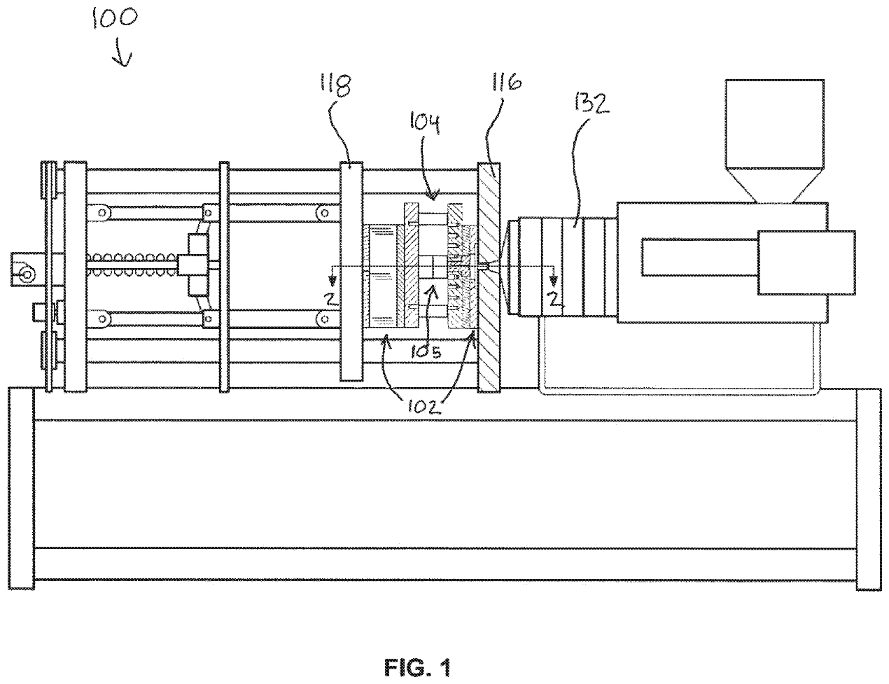

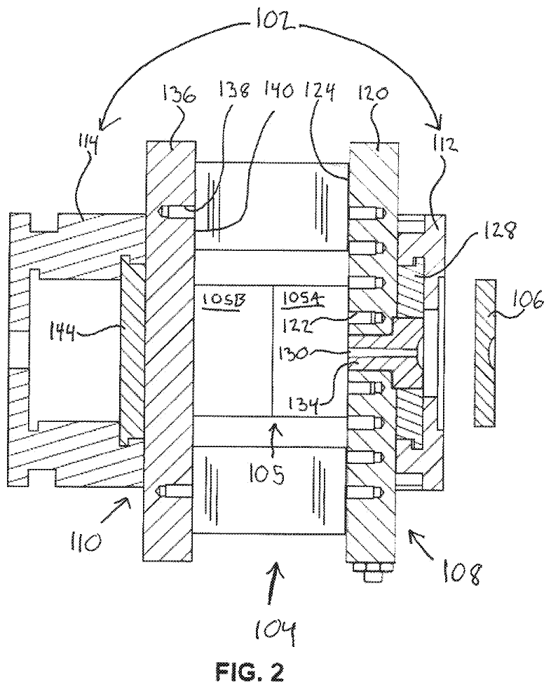

Referring to FIGS. 1 and 2, FIG. 1 is a partially sectioned side view of an injection molding machine 100 having a mold base 102 mounted therein. A mold sub-platen assembly 104 is coupled to the mold base 102, and a mold 105 is mounted in the mold sub-platen assembly 104. As shown herein, mold base 102 is a MUD® QUICK-CHANGE™ System available from DME Company LLC of Madison Heights Mich. U.S.A.; however, the mold sub-platen assembly 104 can be used with other mold base systems, a non-limiting example of which includes a F.I.T.S.® Frame available from PCS Company of Fraser Mich. U.S.A. FIG. 2 is a sectional view of the mold base 102 and the mold sub-platen assembly 104 taken along line 2-2 of FIG. 1 and showing a sectional view of a blocking plate 106 which can optionally be used with the mold sub-platen assembly 104.

The mold sub-platen assembly 104 includes a stationary side sub-platen 108 and a moving side sub-platen 110. The stationary side sub-platen 108 is attachable to a stationary side portion 112 of the mold base 102, and the moving side sub-platen 110 is attachable to a moving side portion 114 of the mold base 102. The stationary side and moving side portions 112, 114 of the mold base 102 are respectively attachable to the stationary and moving platens 116, 118 of the injection molding machine 100.

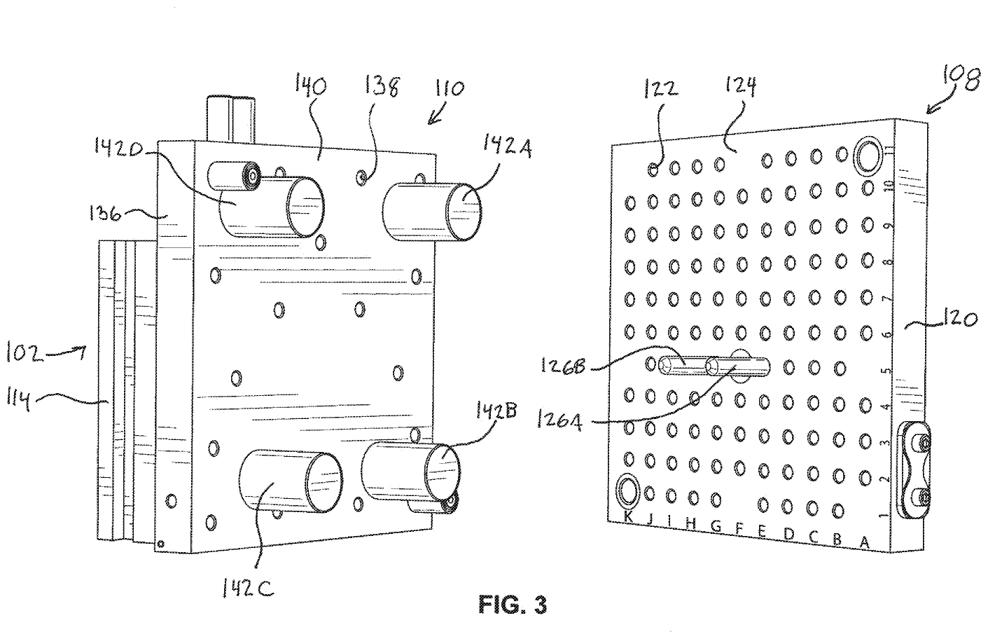

Continuing with FIG. 2 and referring to FIG. 3 which is a perspective view of the mold base 102 and mold sub-platen assembly 104 rotated from their in-use orientation for ease of viewing. The stationary side sub-platen 108 includes a support plate 120 having a first plurality of bores 122 that extend into the support plate 120 from a mounting surface 124 of the support plate 120. The first plurality of bores 122 can be referred to as the bores 122. The bores 122 are arranged in an array, and receive a set of guide pins 126A, 126B of the mold sub-platen assembly 104, that are releasably attached to the support plate 120 by, for example, threaded engagement between each guide pin 126 and a respective bore 122. The set of guide pins 126A, 126B can be referred to as guide pins 126. The guide pins 126 are repositionable among the first plurality of bores 122 to accept different molds. The guide pins 126 optionally include a tool engagable feature, for example wrench flats, to assist with attaching and removing the set of guide pins 126 from the support plate 120.

Continuing with FIG. 2, a stationary side coupling plate 128 is attached to the support plate 120 to facilitate attaching the stationary side sub-platen 108 to the stationary side portion 112 of the mold base 102. As shown, the stationary side coupling plate 128 is a separate plate that is attached to the support plate 120 by, for example, a plurality of fasteners (not shown). Alternatively, the shape and features of the stationary side coupling plate 128 can be included with the support plate 120 such that the support plate 120 and the stationary side coupling plate 128 are a monolithic entity.

An injection passageway 130 extends through the stationary side sub-platen 108. In operation, a machine nozzle 132 (shown in FIG. 1) of the injection molding machine 100 seats against an upstream end of the injection passageway 130 and injections molding material through the injection passageway 130 and into the mold 105. As shown in FIG. 2, the injection passageway 130 is formed in a bushing 134 that is received in the support plate 20. Alternatively, the injection passageway 130 is formed in the support plate 120 or in the support plate 120 and in the stationary side coupling plate 128.

Continuing with FIG. 2 and referring again to FIG. 3, the moving side sub-platen 110 includes a pressing plate 136 having a second plurality of bores 138 that extend into the pressing plate 136 from a pressing surface 140 of the pressing plate 136. The second plurality of bores 138 can be referred to as bores 138. The bores 138 are for releasably attaching a set of support pillars 142A, 142B, 142C, 142D of the mold sub-platen assembly 104 to the pressing plate 136 by, for example, threaded engagement between each support pillar 142 and a respective bore 138. The set of support pillars 142A, 142B, 142C, 142D can be referred to as the support pillars 142. The support pillars 142 limit clamping force generated by the injection molding machine 100 from crushing the mold 105. When the mold 105 is held closed between the support plate 120 and the pressing plate 120, the support pillars 142 seat against the support plate 120. The height or length of the support pillars 142 is equal to or slightly less than, for example 0.5 mm less than, the stack height of the mold 105. The set of support pillars 142 are repositionable among the second array of bores 138 so that, the support pillars 142 extend beside the mold 105 when the mold 105 is held shut by the injection molding machine 100. In an alternative embodiment (not shown), the support pillars 142 are releasably attached to the support plate 120 via the first plurality of bores 122 and extend beside the mold 105. In this configuration, when the mold 105 is held closed between the support plate 120 and the pressing plate 120, the support pillars 142 seat against the pressing plate 136. The support pillars 142 optionally include a tool engagable feature (not shown) for example wrench flats, to assist with attaching and removing the set of support pillars 142 from the pressing plate 136.

Continuing with FIG. 2, a moving side coupling plate 144 is attached to the pressing plate 136 to facilitate attachment of the moving side sub-platen 110 to the moving side portion 114 of the mold base 102. As shown, the moving side coupling plate 144 is a separate plate that is attached to the pressing plate 136 by, for example, a plurality of fasteners (not shown). Alternatively, the shape and features of the moving side coupling plate 144 can be included with the pressing plate 136 such that the pressing plate 136 and the moving side coupling plate 144 are a monolithic entity.

The mold sub-platen assembly 104 can optionally includes a spacer or set of spacers (not shown) that are sandwiched between pressing plate 136 and moving side coupling plate 144, to move the pressing plate 136 closer to the support plate 120 if the stroke of the moving platen 118 is insufficient to close the mold 105.

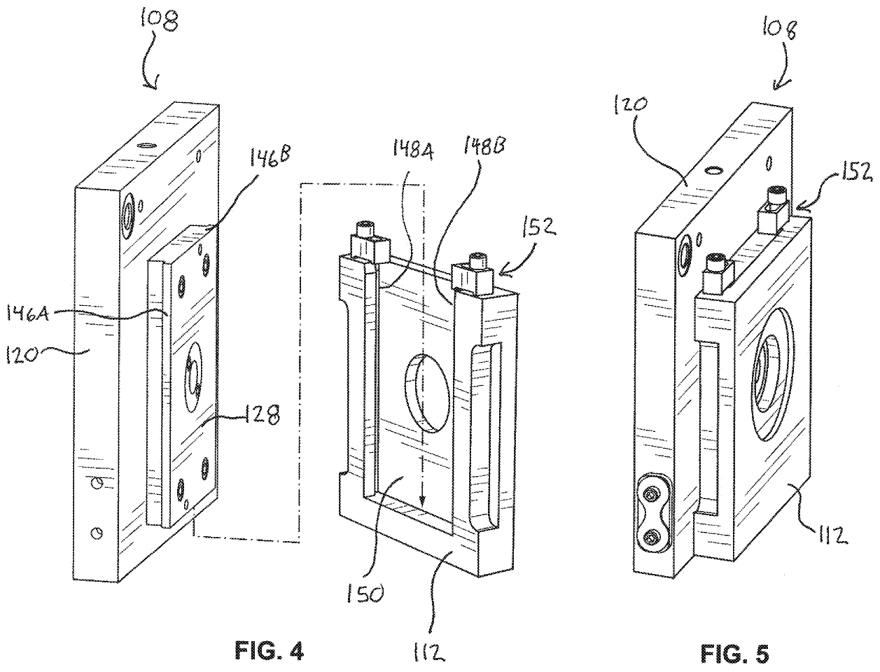

Referring now to FIGS. 4 and 5 in which FIG. 4 is a perspective view depicting assembly of the stationary side sub-platen 108 with the stationary side portion 112 of the mold base 102, and FIG. 5 is a perspective view of the stationary side sub-platen 108 assembled with the stationary side portion 112 of the mold base 102. The stationary side coupling plate 128 includes a first pair of tabs 146A, 146B that extend along its longitudinal sides and are spaced apart from support plate 120. Tabs 146A, 146B are sized to be received in correspondingly sized slots 148A, 148B, that extend outward from the longitudinal sides of a pocket 150 that extends into the stationary side portion 112 of the mold base 102. When the stationary side coupling plate 128 is seated in the pocket 150, clamping members 152 secure stationary side sub-platen 108 to the stationary side portion 112 of the mold base 102.

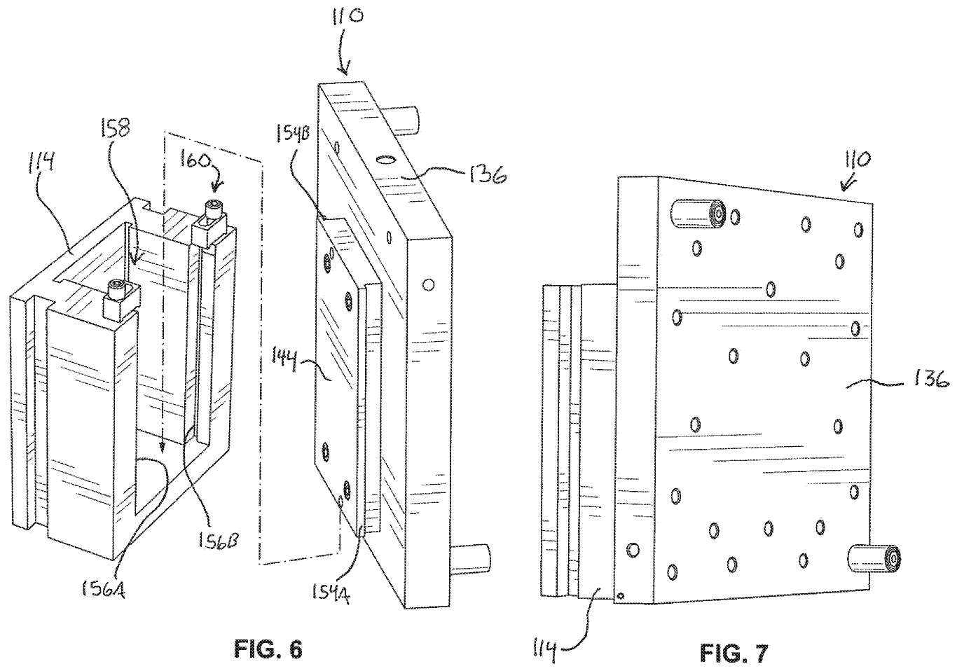

Referring now to FIGS. 6 and 7 in which FIG. 6 is a perspective view depicting assembly of the moving side sub-platen 110 with the moving side portion 114 of the mold base 102 and FIG. 7 is a perspective view of the moving side sub-platen 110 assembled with the moving side portion 114 of the mold base 102. Similar to the stationary side coupling plate 128, the moving side coupling plate 144 includes a pair of tabs 154A, 154B that extend along its longitudinal sides and are spaced apart from the pressing plate 136. Tabs 154A, 154B are sized to be received in correspondingly sized slots 156A, 156B, that extend outward from the longitudinal sides of a pocket 158 that extends into the moving side portion 114 of the mold base 102. When the moving side coupling plate 144 is seated in the pocket 158, clamping members 160 secure moving side sub-platen 110 to the moving side portion 114 of the mold base 102.

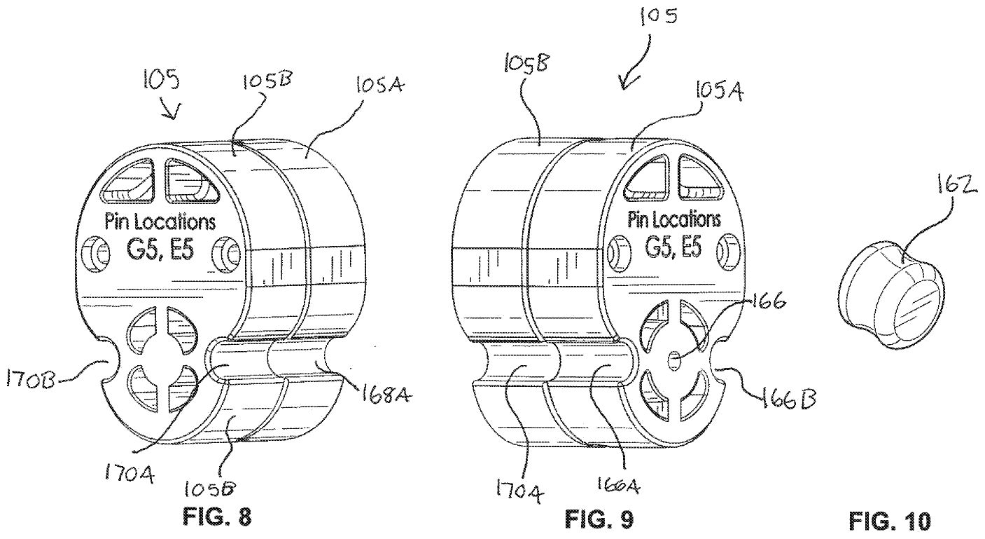

Referring to FIGS. 8-10 in which FIG. 8 is a front perspective view of a non-limiting example of a first mold 105 which is suitable for use with the mold sub-platen assembly 104; FIG. 9 is a rear perspective view of the first mold 105; and FIG. 10 is a perspective view of a molded article 162 which the first mold 105 is shaped to form. The mold 105 is made from a material that facilitates relative quick manufacturing in comparison to the time required to manufacture a production mold. Non-limiting examples of such a material includes a 3D printable UV cured polymer having a relatively high glass transition point, and an aluminum alloy such as 7050 aluminum alloy.

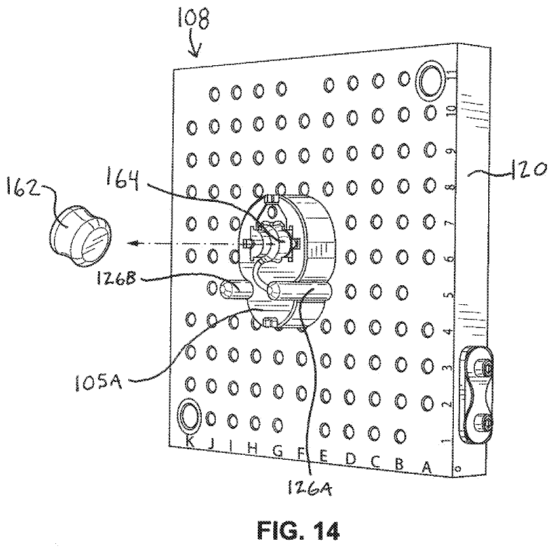

The mold 105 includes a first mold half 105A, and a second mold half 105B. The first mold half 105A can be a cavity side of the mold 105 and the second mold half 105B can be a core side of the mold 105. Together, the first mold half 105A and the second mold half 105B define a mold cavity 164, that is partially visible in FIG. 14, which is a a perspective view showing extraction of the article 162 formed in the first mold 105 from the mold cavity 164 in which it was formed. The mold cavity 164 defines the shape of the molded article 162 that is formed within the mold 105. The first mold half 105A includes a mold inlet passageway 166 through which molding material is injected to the mold cavity 164. The first mold half 105A includes a first plurality guide openings 168A, 168B extend through the first mold half 105A. The second mold half 105B includes a second plurality of guide openings 170A, 170B that extend from the first plurality of guide openings 168A, 168B and into the second mold half 105B. The first plurality of guide openings 168A, 168B can be referred to as guide openings 168 and the second plurality of guide openings 170A, 170B can be referred to as guide openings 170. The guide openings 168, 170 can be completely within the first and second mold halves 105A 105B or, as shown in FIGS. 8 and 9, can be partially surrounded by the first and second mold halves 105A 105B. This configuration can reduce the amount of friction between the mold 105 and the set of guide pins 126 as the mold 105 is installed onto and removed from the support plate 120.

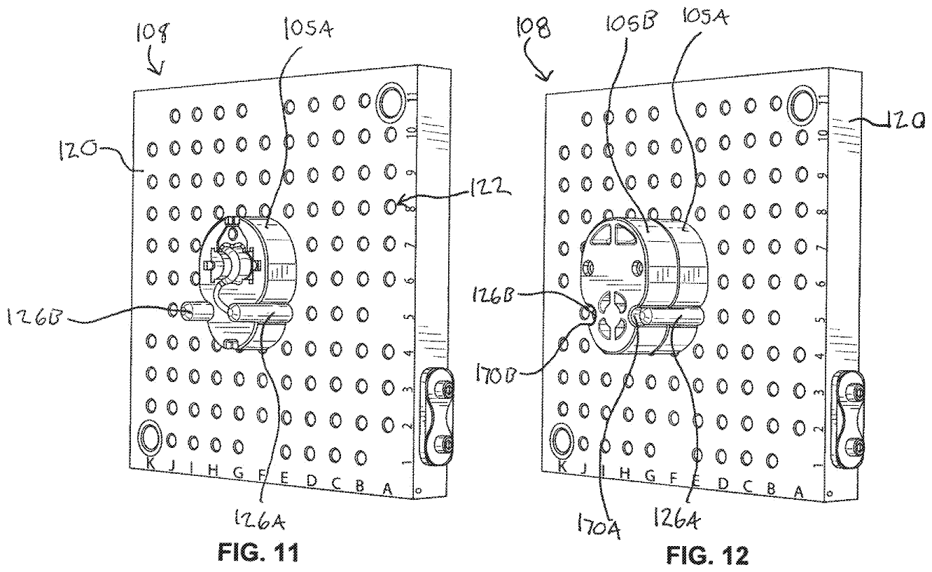

Continuing with FIGS. 8 and 9 and referring to FIG. 11, which is a perspective view of the first mold half 105A installed on the stationary side sub-platen 108. The first plurality of guide openings 168 are sized to allow the first set of guide pins 126 to pass through the first mold half 105A to facilitate installing the first mold half 105A on the first set of guide pins 126 and against the support plate 120 of the stationary-side sub-platen 108. The first plurality of guide openings 168 are formed in the first mold half 105A at locations that correspond to a set of the first plurality of bores 122 in the support plate 120. The first plurality of guide openings 168 are spaced apart from the inlet passageway 166 such that when the first mold half 105A is installed on the support plate 120, with the first set of guide pins 126 passing through the first plurality of guide openings 168, the inlet passageway 166 is aligned with the injection passageway 130 (shown in FIG. 2) that extends through the stationary side sub-platen 108. As shown, the mold includes coordinates that correspond to the bores 122 in the support plate 120 in which the guide pins 126 are to be installed.

Continuing with FIGS. 8 and 9 and referring to FIG. 12, which is a perspective view showing the first mold half 105A and the second mold half 105B installed on the stationary side sub-platen 108. When the second mold half 105B is installed on the support plate 120 the set of guide pins 126 extend from the support plate 120, through the first plurality of guide openings 168 in first mold half 105A, and into the second plurality of guide openings 170 in the second mold half 105B. As shown in FIGS. 8 and 9, the guide openings 170 extend fully through or across the second mold half 105B. Alternatively, the guide openings 170 extend only partially across the second mold half 105B and the guide pins 126 is short enough to allow the first and second mold halves 105A, 105B to be brought together. In operation, the set of guide pins 126 align and support the first and second mold halves 105A, 1056 with each other. The length of the guide pins 126 is generally less than the stack height of the mold 105 so that in operation, the guide pins 126 cannot interfere with the pressing plate 136 when the mold 105 is sandwiched between the support plate 120 and the pressing plate 136.

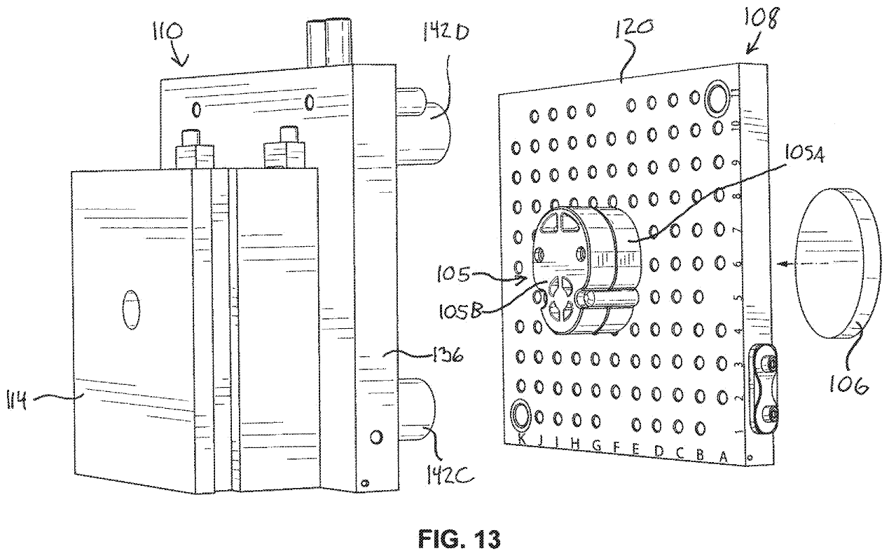

Referring again to FIG. 2, and also referring to FIG. 13, which is a perspective view of the assembled moving side sub-platen 110 and moving side portion 114 of the mold base 102 separated from the stationary side sub-platen 108 and the first prototype mold 105. The blocking plate 106 is removably positioned on the on the upstream side of the stationary side sub-platen 108. In operation the blocking plate 106 is sandwiched between the machine nozzle 132 and the stationary side sub-platen 108. The blocking plate 106 prevents molding material from exiting the machine nozzle 132 in order to build back pressure of molding material in the machine nozzle 132, which promotes proper fill and packing of the mold cavity 164. As an alternative to the blocking plate 106, the machine nozzle 132 can be fitted with a shut-off nozzle (not shown) which prevents molding material from exiting the machine nozzle 132 in order to build back pressure of molding in the machine nozzle 132. Sufficient back pressure in the machine nozzle 132 promotes proper filling and packing of the mold cavity 164. Without the blocking plate 106 or a shut-off nozzle, the injection molding machine 100 more slowly builds up to the desired injection pressure while shot of molding material is injected into the mold cavity 164. Building injection pressure while injecting a shot of molding material is injected into the mold cavity 164 can cause an incomplete filling of the mold cavity 164, which is known in the art as a “short-shot”. A “short shot” is undesirable as it likely creates a non-usable part and is further undesirable in a prototype molding application since each injected shot of molding material into the mold cavity 164, be it a short-shot of molding material or a complete filing of the mold cavity, reduces the generally limited life cycle of the mold 105.

Referring to FIG. 1, method of injection molding using the mold sub-platen assembly 104 with the mold 105 will now be described.

Referring to FIG. 11, an operator installs the first mold half 105A on to the set of guide pins 126 that extend from the support plate 120.

Referring to FIG. 12, the operator then installs the second mold half 105B on to the set of guide pins 126.

Referring to FIG. 1, the operator then activates the molding machine 100 to advance the moving platen 118 towards the stationary platen 116, which moves the pressing plate 136 from its retracted position, as shown in FIG. 13, to its advanced position in which the mold 105 is sandwiched between the pressing plate 136 and the support plate 120. The support pillars 142 seat against the support plate 120 to prevent the clamping force generated by the molding machine 100 from damaging the mold 105.

The operator then activates the injection molding machine 100 to increase back pressure within the machine nozzle 132, either by using the blocking plate 106 or a shut-off nozzle as described above.

When sufficient back pressure is realized in the machine nozzle 132, the operator activates the injection molding machine 100 to inject and hold a shot of molding material through the injection passageway 130 and into the mold cavity 164, via the inlet passageway 166.

After the newly injected molding material has sufficiently solidified within in the mold cavity 164, the operator activates the molding machine 100 to retract the moving platen 118 away from the stationary platen 116. Retracting the moving platen 118 separates the pressing plate 136 from the second mold half 105B and allows the operator to have access the mold 105.

The operator then separates the second mold half 105B from the first mold half 105A to expose the newly molded article 162, and then extracts the newly molded article 162 from the mold cavity 164, as shown in FIG. 14.

In the preceding embodiments, the mold sub-platen assembly 104 is shown having one set of guide pins 126, one set of support pillars 142 and one injection passage bushing 134 that are sized to accommodate the first mold 105. However, the mold sub-platen assembly 104 is not limited to a molds that fit with the set of guide pins 126 and support pillars 142. The mold sub-platen assembly 104 can include multiple sets of guide pins, support pillars and injection passage bushings, which permit the mold sub-platen assembly 104 to be used with a variety of differently shaped molds.

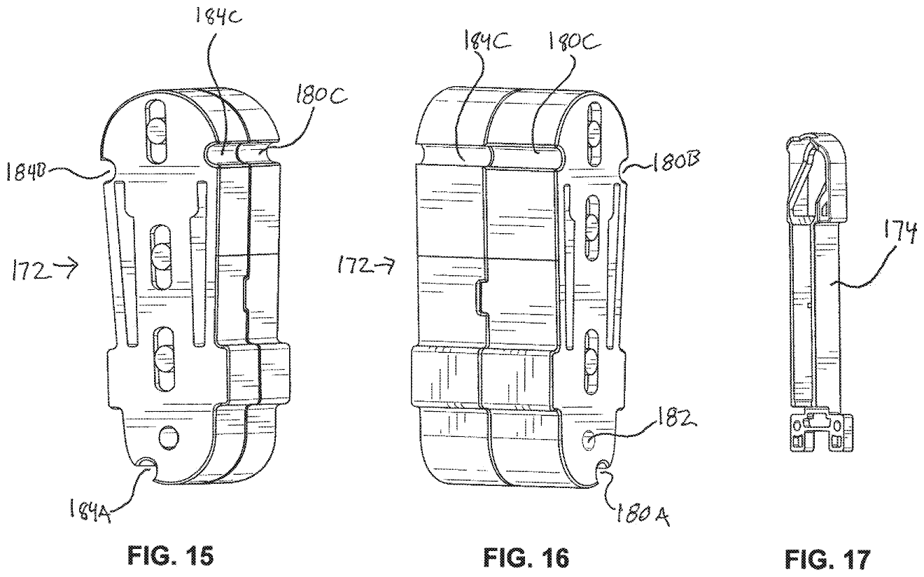

Referring to FIGS. 15-17 in which FIG. 15 is a front perspective view of a non-limiting example of a second mold 172 which is suitable for use with the mold sub-platen assembly 104; FIG. 16 is a rear perspective view of the second mold 172; and FIG. 17 is a perspective view of a molded article 174 which the second mold 172 is shaped to form.

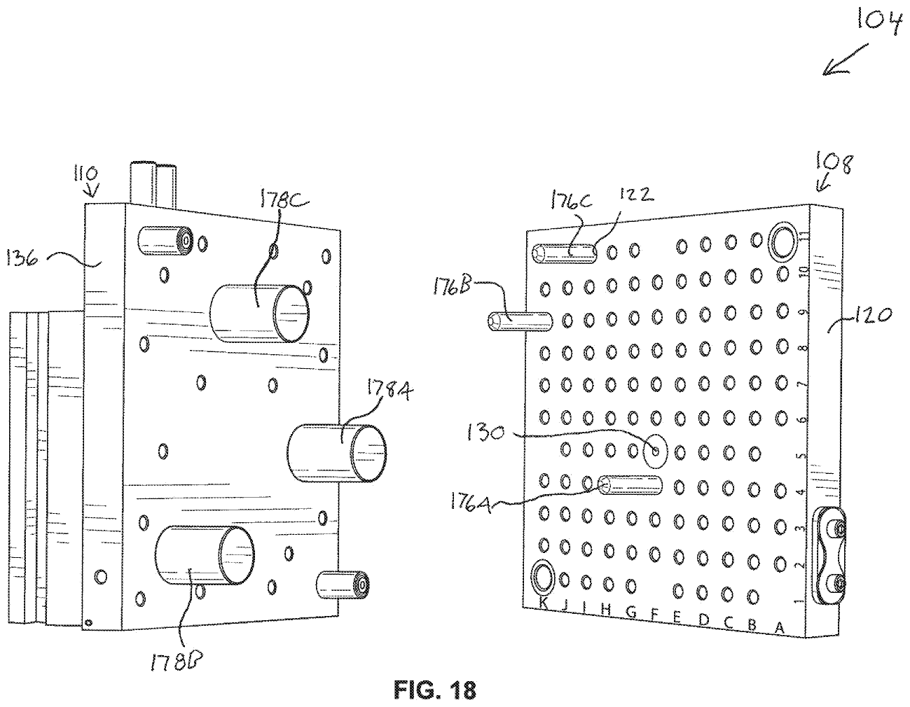

Continuing with FIGS. 15-17 and referring to FIG. 18 which is a perspective view of the mold sub-platen assembly 104 configured to receive the second mold 172. As shown in FIG. 18 the mold sub-platen assembly 104 is rotated from its in-use orientation for ease of viewing. The mold sub-platen assembly 104 is shown having a second set of guide pins 176A, 176B, 176C and a second set of support pillars 178A, 178B, 178C.

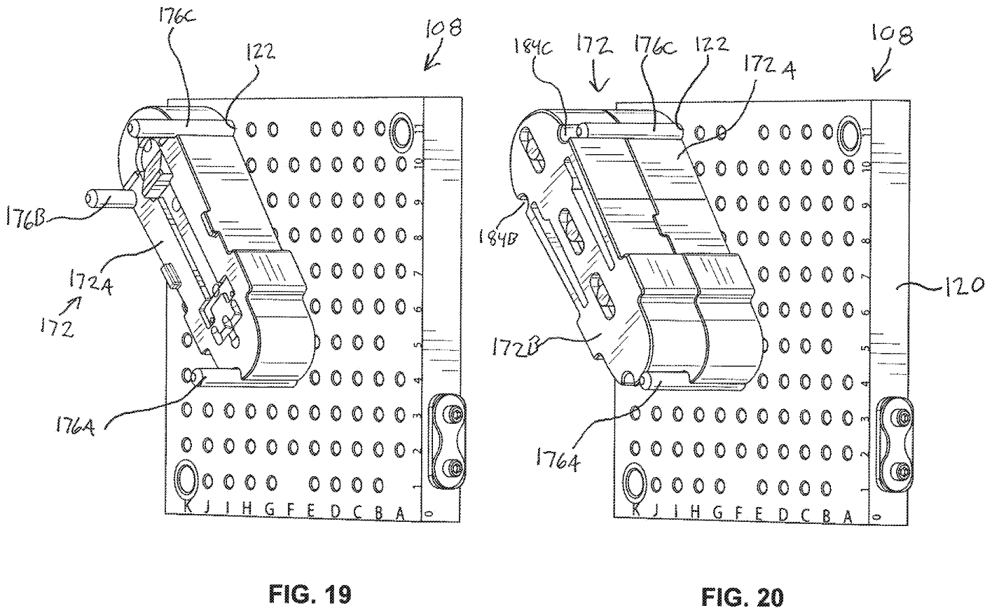

Continuing with FIG. 18 and also referring to FIGS. 19 and 20 in which FIG. 19 is a perspective view of the first half 172A of the second mold 172 installed on the stationary side sub-platen 108 and FIG. 20 is a perspective view of the first half 172A of the second mold 172 and the second half 1726 of the second mold 172 installed on the stationary side sub-platen 108. The guide pins 176 are releasably attached to the support plate 120 via respective bores 122 in support plate 120 which permit the guide pins 176 to pass through respective guide openings 180A, 180B, 180C in the first mold half 172A. The guide openings 180 extend across the first mold half 172A and are spaced apart from an inlet passageway 182 (shown in FIG. 16) in the first mold half 172A such that when the first mold half 172A is installed on the support plate 120 (as shown in FIG. 19), the inlet passageway 182 is aligned with the injection passageway 130 (shown in FIG. 18) that extends through the stationary side sub-platen 108. When the second mold half 172B is installed on the support plate 120 (as shown in FIG. 20) the guide pins 176 extend from the mounting plate 120, through the guide openings 180 in first mold half 172A, and into guide openings 184A, 184B, 184C in the second mold half 172B.

The support pillars 178 are releasably attached to the pressing plate 1136 via respective bores 138 that are located to permit the support pillars 178 to extend beside the mold 172 when the mold 172 is held shut between the mounting plate 120 and the pressing plate 136.

As can be seen when comparing the set of two guide pins 126 (shown in FIGS. 3, 11, 12, 13, 14) to the set of three guide pins 176 (shown in FIGS. 18 to 20), the guide pins 126, 176 can be different in number and/or size (length and/or diameter).

As can be seen when comparing the set of four support pillars 142 (shown in FIGS. 3 and 13) to the set of three support pillars 178 (shown in FIG. 18), the support pillars 142, 178 can be different in number and/or size (length and/or diameter).

Having a variety sizes and numbers of sets of guide pins 126, 176 and support pillars 142 178 allows the mold sub-platen assembly 104 to be used with a range of molds.

The guide pins 126, 176 and the support pillars 142, 178 can be supplied to an end user in standardized sizes, and a mold can be built to accommodate the standardized size guide pins 126, 176 and support pillars 142, 178. Alternatively, the guide pins 126, 176 and the support pillars 142, 178 can be supplied to an end user in standardized sizes and are machined or finished to a specific size to accommodate a mold.

The mold sub-platen assembly 104 can also include a plurality of bushings 134 having a differently sized injection passageways. Which can be selectively used with the mold sub-platen assembly 104 depending on the size or material of a molded article formed in a mold.

While various embodiments have been described above, they have been presented as illustrations and examples, and not by way of limitation. It will be apparent to persons skilled in the relevant art that various changes in form and detail can be made therein without departing from the spirit and scope of the invention. Thus, the breadth and scope of the present invention should not be limited by any of the above-described embodiments but should be defined only in accordance with the appended claims and their equivalents. It will also be understood that each feature of each embodiment discussed herein, and of each reference cited herein, can be used in combination with the features of any other embodiment.

What is claimed is:

1. An injection molding apparatus for use with a mold base system, the injection molding apparatus comprising:
a mold sub-platen assembly including a stationary side sub-platen releasably attachable to a stationary side portion of the mold base which is mountable to a stationary platen of an injection molding machine, and a moving side sub-platen releasably attachable to a moving side portion of the mold base which is mountable to a moving platen of the injection molding machine.

2. A method of injection molding comprising:
Attaching a set of guide pins to a stationary sub-platen at predetermined locations that correspond to guide openings that extend through a first half of a mold;
installing the first half of the mold on the stationary sub-platen such that the guide pins extend through the guide openings that extend through the first half of the mold; and
installing a second half of the mold on the stationary sub-platen such that the guide pins extend into openings that extend into the second half of the mold and are aligned with the guide openings that extend through the first half of the mold.
